(19) United States
(12) Patent Application Publication
(10) Pub. No.: US 2022/0081779 A1
(43) Pub. Date: Mar. 17, 2022

(54) TREATING METHOD OF METAL SURFACE AND COATING METHOD THEREOF USING THE SAME

(71) Applicant: LG ELECTRONICS INC., Seoul (KR)

(72) Inventors: Sangheon SONG, Seoul (KR); Jin Woo Shim, Seoul (KR); Jong Hun Lim, Seoul (KR); Younghyun Park, Seoul (KR)

(73) Assignee: LG ELECTRONICS INC.

(21) Appl. No.: 17/471,625

(22) Filed: Sep. 10, 2021

(30) Foreign Application Priority Data
Sep. 14, 2020 (KR) 10-2020-0117655

(51) Int. Cl. C23G 5/00; C01B 32/50; C11D 7/02; C11D 11/00; C23D 5/02

(52) U.S. Cl. CPC C23G 5/00; C01B 32/50; C23D 5/02; C11D 11/0029; C11D 7/02

(57) ABSTRACT

The present disclosure relates to a treating method of a metal surface, and a coating method thereof using the same. A treating method of a metal surface may include grinding solid carbon dioxide and then spraying the ground solid carbon dioxide onto a metal surface. After spraying the ground solid carbon dioxide, irradiating short-wavelength ultraviolet rays on the metal surface, thereby removing foreign substances attached to the metal surface, reforming the metal surface into a hydrophilic surface and improving wettability of a coating material.

### CROSS-REFERENCE TO RELATED APPLICATION

This application claims priority to and the benefit of Korean Patent Application No. 10-2020-0117655, filed in Korea on Sep. 14, 2020, the subject matter of which is hereby incorporated by reference.

### BACKGROUND

### 1. Field

The present disclosure discloses a treating method of a metal surface and a coating method thereof using the same. More specifically, the present disclosure discloses a treating method of a metal surface and a coating method thereof using the same in order to remove a foreign substance and an oil film on a metal surface and to coat the metal surface with a glass film that is dense, thin and transparent.

### 2. Background

Stainless steel has been used for components of a variety of home appliances such as a refrigerator, a washing machine, a dishwasher, an air conditioner and the like. When the home appliances are manufactured, a process of removing cutting oil and foreign substances from an outer surface of stainless steel (used for various types of components of the home appliances) may need to be performed.

To remove the cutting oil and foreign substances from stainless steel, a degreasing process may first be performed. Degreasing is a process in which cutting oil or a foreign substance on a surface of stainless steel is washed in trichloroethylene of 70-80° C. using ultrasonic waves for 10-20 minutes, submerged in ion exchanged water of the room temperature for 1 minute and then is washed using an alkaline liquid degreaser.

After the degreasing process, a passivation process may be performed. Passivation is a process in which stainless steel is submerged in a passivation liquid of 45-60° C. for 20-30 minutes to increase corrosion resistance and then submerged in ion exchange water of 50-70° C. for 1 minute to wash the passivation liquid.

Various types of processes can be performed to remove cutting oil and foreign substances attached onto a surface of stainless steel and improve quality of the stainless steel. However, it is not easy to perfectly remove the cutting oil and the foreign substances on an outer surface of the stainless steel. Additionally, a chromate stain or a water stain can be left on edges and in holes of the stainless steel during a wet type washing process, resulting in a reduction in corrosion resistance and in cleanliness of the stainless steel.

A method for forming a water-soluble inorganic coating layer is disclosed in KR Patent Publication No. 10-2007-0066241 (published Jun. 27, 2007), the subject matter of which is incorporated herein by reference. In the method, an anodizing process or an etching process and/or the like is used as a treating process applied to a surface of a base material. However, in the treating process, impurities on the surface of the base material may not be removed perfectly.

Simple washing and coating methods applied to a surface of stainless steel used to manufacture home appliances are disclosed in U.S. Patent Publication No. 2014/0178591 (published Jun. 26, 2014), the subject matter of which is incorporated herein by reference. In the methods, a wet type degreasing process, an acidification process, a hydroxylation process and/or the like are applied to coat the surface of the stainless steel. However, in the methods, an alkaline degreaser and large amounts of water are used, resulting in an adverse effect on the environment.

A cleaning agent for stainless steel is disclosed in KR Patent Publication No. 10-2008-0027610 (published Mar. 28, 2008), the subject matter of which is incorporated herein by reference. The cleaning agent includes tetramethyl ammonium hydroxide used to readily remove foreign substances left on steel and to prevent corrosion of stainless steel, an organic solvent and water. However, the use of large amounts of the organic solvent and water may result in an adverse effect on the environment and may make it difficult to apply the cleaning agent to a large facility.

### BRIEF DESCRIPTION OF THE DRAWINGS

Embodiments will be described in detail with reference to the following drawings in which like reference numerals refer to like elements, and wherein:

FIG. 1 is a flow chart showing a treating method of a metal surface according to the present disclosure;

FIG. 2 is a flow chart showing a coating method of a metal surface according to the present disclosure;

FIG. 3 is a picture showing a spray of solid carbon dioxide in a treating method and coating method of a metal surface according to the present disclosure;

FIG. 4 is a picture showing irradiation of short-wavelength ultraviolet rays in a treating method of a metal surface and a coating method of a metal surface according to the present disclosure; and

FIG. 5 is a picture showing a spray of a coating material in a coating method of a metal surface according to the present disclosure.

### DETAILED DESCRIPTION

A treating method of a metal surface and a coating method of a metal surface according to the present disclosure may be described. A treating method of a metal surface according to the present disclosure may include grinding solid carbon dioxide (CO₂) and then spraying the ground solid CO₂ onto a metal surface, and irradiating short-wavelength ultraviolet rays on the metal surface after spraying the ground solid CO₂.

To solve problems with wet type process of disadvantageous arrangements, the treating method of a metal surface according to the present disclosure may help to suppress generation of wastewater and prevent environmental pollution, caused by use of an alkaline degreaser and large amounts of water, and help to reduce investments incurred for large facilities and a space occupied by a large facility.

Additionally, in the treating method according to the present disclosure, foreign substances and oily ingredients attached onto the metal surface may be removed more perfectly using the solid CO₂ than in the wet type cleaning method of the disadvantageous arrangements.

The short-wavelength ultraviolet rays may be irradiated after spraying the ground solid CO₂ to reform the metal surface into a hydrophilic surface, thereby improving wettability of a coating material coated on the metal surface.

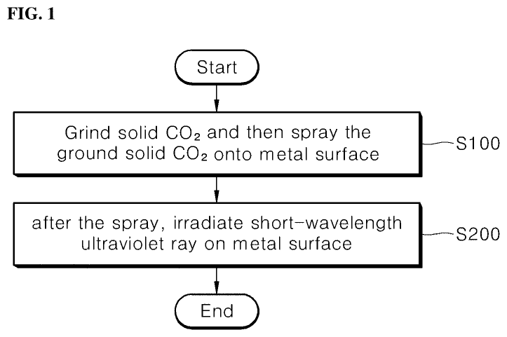

FIG. 1 is a flow chart showing a treating method of a metal surface according to the present disclosure. The treating method of a metal surface according to the present disclosure may include grinding solid carbon dioxide (CO₂) and then spraying the ground solid CO₂ onto a metal surface (S100).

To coat a metal surface (such as stainless steel) applied to an exterior of a home appliance with a transparent glass film, foreign substances and oily ingredients on the metal surface may need to be removed from the metal surface. In the present disclosure, the metal surface may be cleaned using solid CO₂ instead of the wet process in which large amounts of degreaser and water are used, and the foreign substances on the metal surface may be removed as a result of crack, thermal impact and hygral expansion by the sprayed solid CO₂.

The solid CO₂ may be sprayed onto the metal surface by compressed air. The compressed air may be formed through a dry-filter, and the solid CO₂ may be ground to have a size of 0.5-3.0 mm by using a mash net disposed in a middle of a spray nozzle.

When the solid CO₂ has a size of less than 0.5 mm, the solid CO₂'s performance of cleaning the metal surface may deteriorate. When the solid CO₂ has a size of greater than 3.0 mm, the metal surface may be damaged.

Additionally, the solid CO₂ may be sprayed at a pressure of 5˜7 bar, for example. When the spray pressure is less than 5 bar, a spray speed of the solid CO₂ may decrease, causing deterioration of the solid CO₂'s performance of cleaning the metal surface. When the spray pressure is greater than 7 bar, noise may be too loud to perform work.

An amount of the sprayed solid CO₂ may be 40-60 kg/hr, for example. When the amount of the sprayed solid CO₂ is less than 40 kg/hr, density of the solid CO₂ sprayed per unit area may be low, causing deterioration of the solid CO₂'s performance of cleaning the metal surface. When the amount of the sprayed solid CO₂ is greater than 60 kg/hr, the solid CO₂ may be excessively used, thereby causing degradation in processing efficiency.

The treating method according to the present disclosure may include irradiating short-wavelength ultraviolet rays on the metal surface (S200) after spraying the ground solid CO₂. In the treating method according to the present disclosure, when short-wavelength ultraviolet rays are irradiated on the metal surface, molecular oxygen in the air may decompose, active oxygen may be induced, the active oxygen along with the short-wavelength ultraviolet rays may decompose a coupling of an organic layer present on the metal surface, to form a hydrophilic functional group such as a carboxyl group (—COOH), a hydroxyl group (—OH) and the like.

In this example, wavelengths of the short-wavelength ultraviolet rays may be 185-254 nm, for example. When the wavelength is less than 185 nm, the decomposition may not be implemented. When the wavelength is greater than 254 nm, tact time may be too long, making it difficult to mass-produce the coating material.

Additionally, light energy is inversely proportional to the square of a distance. Thus, the activation effect may be reduced. The short-wavelength ultraviolet rays may be irradiated at a distance of 60 mm or less away from the metal surface, for example.

The short-wavelength ultraviolet rays may be irradiated (or provided) for 100 seconds or greater, for example, or irradiated twice for 100 seconds (i.e., once every 50 seconds). When the short-wavelength ultraviolet rays are irradiated for less than 100 seconds, spreadability of the coating material may decrease, thereby causing deterioration of an exterior such as a crack, swelling, unevenness, orange peeling and the like of the coating film.

In the present disclosure, a coating method of a metal surface may be provided that includes grinding solid CO₂ and spraying the ground solid CO₂ onto a metal surface, irradiating short-wavelength ultraviolet rays on the metal surface after spraying the ground solid CO₂, and spraying a coating material onto the metal surface on which the ultraviolet rays are irradiated.

In the coating method according to the present disclosure, a small-scale treating facility is needed thereby reducing facility investment and scaling down production lines. There is no limitation on the selection of an area for disposing of wastewater, thereby making it possible to freely select a plant site.

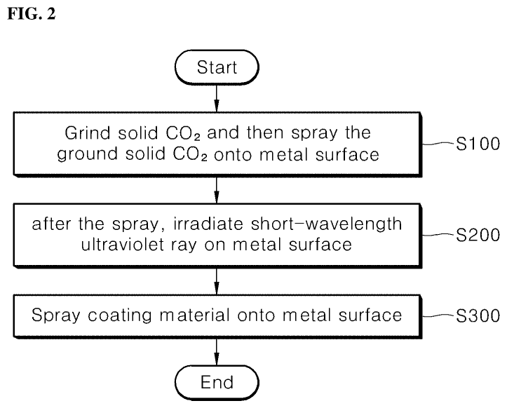

FIG. 2 is a flow chart showing a coating method of a metal surface according to the present disclosure. The coating method of a metal surface according to the present disclosure may include grinding solid CO₂ and then spraying the ground solid CO₂ onto a metal surface (S100), and then irradiating (or providing) short-wavelength ultraviolet rays on the metal surface (S200) after spraying the ground solid CO₂. The steps (or operations) of spraying the solid CO₂ and irradiating the short-wavelength ultraviolet rays may be the same as the spray and irradiation steps (or operations) described above.

The coating method according to the present disclosure may include spraying a coating material onto the metal surface on which the ultraviolet rays are irradiated (S300).

A liquid coating material may be supplied to a spray nozzle, and sprayed onto the metal surface using compressed air while being fine-grained and patterned. The fine-grained coating material may be supplied using an evaporation pump.

A ratio of automization pressure and patternization pressure for the spray may be 1:1 to 1:1.5, for example. However, out of the ratio, a spray pattern may not be uniform and a coating film may hardly be planarized.

When the coating material is sprayed, an amount of the sprayed coating material may be 15-20 cc/min, for example. When the amount of the sprayed coating material is less than 15 cc/min, the coating film may not be formed densely, thereby making it difficult to implement a coating film having aesthetic properties. When the amount of the sprayed coating material is greater than 20 cc/min, the coating film may become thick, and a solvent inside the coating film may boil under high-temperature hardening conditions, resulting in whitening of the coating film.

Additionally, when the coating material is sprayed, a distance from the nozzle to the metal surface may be 140-180 mm, for example. When the distance is less than 140 mm, the coating material may reach the metal surface before the coating material is sufficiently fine-grained, making it difficult to ensure a smooth surface. When the distance is greater than 180 mm, a sufficient arrival rate of the coating material may not be ensured, making it difficult to implement a coating film.

When the coating material is sprayed, a movement speed of the nozzle may be 650-1,200 mm/sec, for example. A movement speed of less than 650 mm/sec may not be appropriate for mass-production. A movement speed of greater than 1,200 mm/sec may make it hard for the fine-grained coating material to reach the metal surface. Thus, it may be difficult to implement a coating film.

The coating method according to the present disclosure may further include a drying process and a hardening process after the coating material is sprayed.

The drying and hardening processes may be performed in a thermal dryer including a near-infrared heater and a hardening furnace, and a metallic material, to which a liquid coating material is applied, may be put into and then taken out of a continuous conveyor for the drying and hardening processes.

The drying process may be performed at 100° C. for 5-10 minutes. When the drying process is performed for less than 5 minutes, a portion where there are lumps of the coating material may be cut during the hardening process since proper spreadability of the coating material is not ensured. When the drying process is performed for greater than 10 minutes, efficiency of processing may not be ensured.

The hardening process may be performed at 350° C. for 15 minutes or greater or at 400° C. for 10 minutes. When the hardening temperature and time is not within the range, a coupling in the coating material may not properly performed thereby reducing chemical resistance and moisture resistance may deteriorate.

The coating method of a metal surface according to the present disclosure may further include a slow cooling process after the drying and hardening processes.

The slow cooling process may be performed at 10° C. or greater, for example. When the slow cooling process is performed at less than 10° C., the coating film may be broken and cracked since thermal expansion coefficients of the metal and the coating film differ.

The subject matter of the present disclosure may be specifically described with reference to embodiments. The embodiments may be provided only as examples for detailed description. Thus, the subject matter of the present disclosure is not limited by the embodiments.

### EMBODIMENT

### Embodiments 1 to 4: Treating of Metal Surface

1. Spray of Solid CO₂

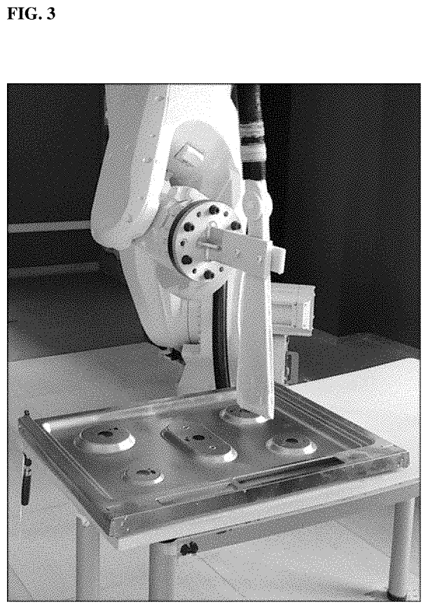

FIG. 3 is a picture showing a spray of solid CO₂ in a treating method of a metal surface according to the present disclosure. The solid CO₂ was carried on compressed air to come out of a nozzle and sprayed from the nozzle to a stainless steel surface at a high pressure. The compressed air was formed through a dry filter, and the solid CO₂ was ground to have a predetermined size using a mesh net disposed in a middle of the nozzle.

2. Irradiation of Short-Wavelength Ultraviolet Rays

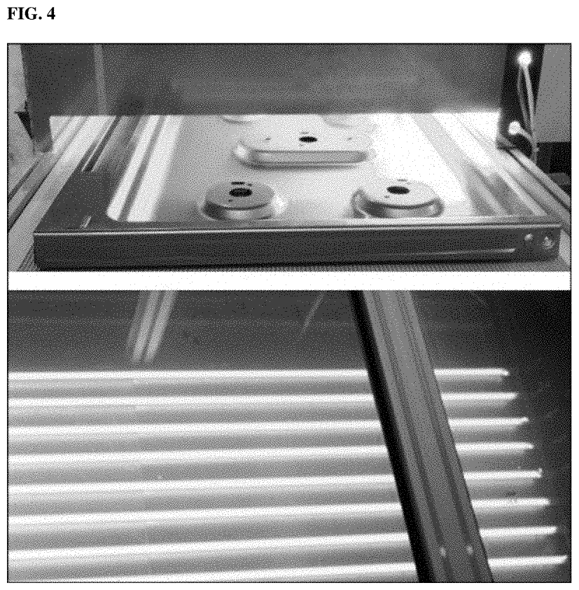

FIG. 4 is a picture showing irradiation of short-wavelength ultraviolet rays in a treating method of a metal surface according to the present disclosure. Referring to FIG. 4, short-wavelength ultraviolet rays were irradiated on the stainless steel surface onto which the solid CO₂ was sprayed, using a low-pressure mercury lamp.

Table 1 (shown below) specifically shows processing conditions in Embodiments 1 to 4.

TABLE 1

| | | Embodiment | Embodiment | Embodiment | Embodiment |
|---|---|---|---|---|---|
| Conditions | | 1 | 2 | 3 | 4 |
| CO₂ spray | Particle size | 0.5 | 0.5 | 0.5 | 2 |
| | (mm) | | | | |
| | Spray | 5 | 5 | 5 | 5 |
| | pressure | | | | |
| | (bar) | | | | |
| | Spray | 60 | 60 | 60 | 60 |
| | amount | | | | |
| | (kg/hr) | | | | |
| UV | Main | 185 | 185 | 185 | 185 |
| irradiation | wavelength | | | | |
| | range (nm) | | | | |
| | Irradiation time | 100 | 100 | 100 | 100 |
| | (sec) | | | | |
| | Light source | 50 | 50 | 50 | 50 |
| | distance | | | | |
| | (mm) | | | | |

### Embodiments 5 to 8: Formation of Coating Film on Metal Surface

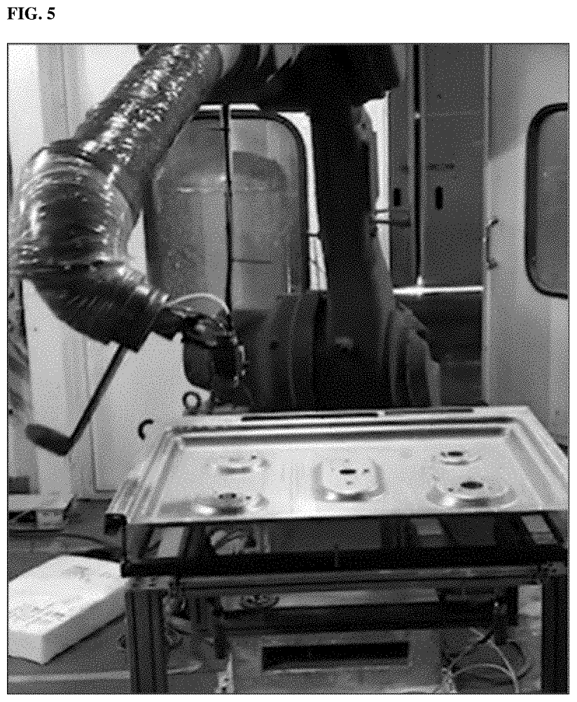

FIG. 5 is a picture showing a spray of a coating material in a coating method of a metal surface according to the present disclosure. FIG. 5 shows that a liquid coating material was supplied to a spray nozzle, and sprayed onto the stainless steel surface, which was cleaned in Embodiments 1 to 4, using the compressed air while being fine-grained and patterned. In this example, the coating material was fine-grained and supplied using an evaporation pump.

Additionally, the stainless steel to which the liquid coating material was applied was transferred to a continuous conveyor, and dried and hardened in a thermal drying and hardening furnace including a near-infrared heater and then taken out.

A slow cooling process is performed after the drying and hardening processes.

### Comparative Examples 1 to 10

Each of the processing conditions in Embodiments 5 to 8 described above was changed, and under the changed conditions, a coating film was formed on the stainless steel surface.

Table 2 (shown below) shows specific processing conditions in Embodiments 5 to 8 and Comparative examples 1 to 10.

TABLE 2

| | | Em- | Em- | Em- | Em- | Com- | Com- | Com- | Com- | Com- | Com- | Com- | Com- | Com- | Com- |
|---|---|---|---|---|---|---|---|---|---|---|---|---|---|---|---|
| | | bod- | bod- | bod- | bod- | para- | parat- | para- | para- | para- | para- | para- | para- | para- | para- |
| | | i- | i- | i- | i- | tive- | ive- | tive- | tive- | tive- | tive- | tive- | tive- | tive- | tive- |
| | | ment | ment | ment | ment | example | example | example | example | example | example | example | example | example | example |
| Conditions | | 5 | 6 | 7 | 8 | 1 | 2 | 3 | 4 | 5 | 6 | 7 | 8 | 9 | 10 |
| CO₂ | Particle | 0.5 | 0.5 | 0.5 | 2 | 0.5 | 0.5 | 0.5 | 0.5 | 0.5 | 0.5 | 0.5 | 0.5 | 0.5 | 3 |
| spray | size | | | | | | | | | | | | | | |
| | (mm) | | | | | | | | | | | | | | |
| | Spray | 5 | 5 | 5 | 5 | 5 | 3 | 5 | 5 | 5 | 5 | 5 | 5 | 5 | 5 |
| | pressure | | | | | | | | | | | | | | |
| | (bar) | | | | | | | | | | | | | | |
| | Spray | 60 | 60 | 60 | 60 | 60 | 35 | 60 | 60 | 60 | 60 | 60 | 60 | 60 | 60 |
| | amount | | | | | | | | | | | | | | |
| | (kg/hr) | | | | | | | | | | | | | | |
| UV | Main | 185 | 185 | 185 | 185 | 185 | 185 | 365 | 185 | 185 | 185 | 185 | 185 | 185 | 185 |
| irrachat | wave- | | | | | | | | | | | | | | |
| | length | | | | | | | | | | | | | | |
| | range | | | | | | | | | | | | | | |
| | (nm) | | | | | | | | | | | | | | |
| | Ir- | 100 | 100 | 100 | 100 | 100 | 100 | 100 | 50 | 100 | 100 | 100 | 100 | 100 | 100 |
| | radiation | | | | | | | | | | | | | | |
| | time | | | | | | | | | | | | | | |
| | (sec) | | | | | | | | | | | | | | |
| | Light | 50 | 50 | 50 | 50 | 50 | 50 | 50 | 50 | 80 | 50 | 50 | 50 | 50 | 50 |
| | source | | | | | | | | | | | | | | |
| | distance | | | | | | | | | | | | | | |
| | (mm) | | | | | | | | | | | | | | |
| Coating | Automi- | 1:1 | 1:1 | 1:1 | 1:1 | 1:1 | 1:1 | 1:1 | 1:1 | 1:1 | 1:2 | 2:1 | 1:1 | 1:1 | 1:1 |
| | zation | | | | | | | | | | | | | | |
| | pressure: | | | | | | | | | | | | | | |
| | patterni- | | | | | | | | | | | | | | |
| | zation | | | | | | | | | | | | | | |
| | pressure | | | | | | | | | | | | | | |
| | Amount | 15 | 20 | 20 | 20 | 20 | 20 | 20 | 20 | 20 | 20 | 20 | 10 | 20 | 20 |
| | of | | | | | | | | | | | | | | |
| | coating | | | | | | | | | | | | | | |
| | material | | | | | | | | | | | | | | |
| | (cc/min) | | | | | | | | | | | | | | |
| Drying | Time | 5 | 5 | 5 | 5 | 5 | 5 | 5 | 5 | 5 | 5 | 5 | 5 | — | 3 |
| (100° C.) | (min) | | | | | | | | | | | | | | |
| Hardening | Time | 15 | 10 | 15 | 15 | 15 | 15 | 15 | 15 | 15 | 15 | 15 | 15 | 10 | 10 |
| (350° C.) | (min) | | | | | | | | | | | | | | |
| Slow | Tem- | — | — | 10 | 10 | — | — | — | — | — | — | — | — | — | 5 |
| cooling | perature | | | | | | | | | | | | | | |
| | (° C.) | | | | | | | | | | | | | | |
| Results | Cleaning | Good | Good | Good | Good | Poor | Poor | Good | Good | Good | Good | Good | Good | Good | Good |
| | Surface | 72 | 72 | 72 | 72 | 60 | 60 | 48 | 56 | 56 | 72 | 72 | 72 | 72 | 72 |
| | energy | | | | | | | | | | | | | | |
| | (dyne/cm) | | | | | | | | | | | | | | |
| | Coating | Good | Good | Good | Good | Good | Good | Poor | Poor | Poor | Good | Good | Poor | Good | Good |
| | work- | | | | | | | | | | | | | | |
| | ability | | | | | | | | | | | | | | |
| | Exterior | Good | Good | Good | Good | Poor | Poor | Poor | Poor | Poor | Poor | Poor | Poor | Poor | Poor |
| | Chemical | Good | Average | Good | Good | Good | Good | Good | Good | Good | Good | Good | Good | Poor | Poor |
| | resistance/ | | | | | | | | | | | | | | |
| | moisture | | | | | | | | | | | | | | |
| | resistance | | | | | | | | | | | | | | |

### EXPERIMENTAL EXAMPLE

### Experimental Example 1: Analysis of State of Stainless Steel Surface, Surface Energy, Wettability, Exterior, and Chemical Resistance/Moisture Resistance

The state, surface energy, wettability and exterior of the stainless steel surface that was cleaned using a treating method according to the present disclosure were analyzed, and the chemical resistance and moisture resistance of the coating film manufactured using the coating method according to the present disclosure are shown in Table 3 (below).

Results of the cleaning and the exterior of the stainless steel surface were checked with the naked eye under the light of 1,000 lux, and results of examination of whether processed poultry oil, protective vinyl residues and the like were left on the stainless steel surface were expressed as good and poor.

To measure workability, short-wavelength ultraviolet rays were irradiated on the stainless steel surface, the coating material was applied to the stainless steel surface using a dyne pen (manufactured by AETP) at 2-4 dyne/cm intervals, and then results of examination of whether lumps of the applied liquid were formed within 3 seconds were expressed as good and poor.

To measure the chemical resistance/moisture resistance, the stainless steel surface was exposed at 85° C. and 85% humidity in a sealed chamber for 48 hours and then naturally dried for 1 hour, and results of examination of whether there were abnormalities on the stainless steel surface were expressed as good and poor.

TABLE 3

| | | Em- | Em- | Em- | Em- | Com- | Com- | Com- | Com- | Com- | Com- | Com- | Com- | Com- | Com- |
|---|---|---|---|---|---|---|---|---|---|---|---|---|---|---|---|
| | | bod- | bod- | bod- | bod- | para- | parat- | para- | para- | para- | para- | para- | para- | para- | para- |
| | | i- | i- | i- | i- | tive- | ive- | tive- | tive- | tive- | tive- | tive- | tive- | tive- | tive- |
| | | ment | ment | ment | ment | example | example | example | example | example | example | example | example | example | example |
| Conditions | | 5 | 6 | 7 | 8 | 1 | 2 | 3 | 4 | 5 | 6 | 7 | 8 | 9 | 10 |
| CO₂ | Particle size | 0.5 | 0.5 | 0.5 | 2 | 0.5 | 0.5 | 0.5 | 0.5 | 0.5 | 0.5 | 0.5 | 0.5 | 0.5 | 3 |
| spray | (mm) | | | | | | | | | | | | | | |
| | Spray | 5 | 5 | 5 | 5 | 3 | 5 | 5 | 5 | 5 | 5 | 5 | 5 | 5 | 5 |
| | pressure | | | | | | | | | | | | | | |
| | (bar) | | | | | | | | | | | | | | |
| | Spray amount | 60 | 60 | 60 | 60 | 60 | 35 | 60 | 60 | 60 | 60 | 60 | 60 | 60 | 60 |
| | (kg/hr) | | | | | | | | | | | | | | |
| UV | Main | 185 | 185 | 185 | 185 | 185 | 185 | 365 | 185 | 185 | 185 | 185 | 185 | 185 | 185 |
| irradiation | wavelength | | | | | | | | | | | | | | |
| | range | | | | | | | | | | | | | | |
| | (nm) | | | | | | | | | | | | | | |
| | Irradiation | 100 | 100 | 100 | 100 | 100 | 100 | 100 | 50 | 100 | 100 | 100 | 100 | 100 | 100 |
| | time (sec) | | | | | | | | | | | | | | |
| | Light source | 50 | 50 | 50 | 50 | 50 | 50 | 50 | 50 | 80 | 50 | 50 | 50 | 50 | 50 |
| | distance | | | | | | | | | | | | | | |
| | (mm) | | | | | | | | | | | | | | |
| Coating | Automization | 1:1 | 1:1 | 1:1 | 1:1 | 1:1 | 1:1 | 1:1 | 1:1 | 1:1 | 1:2 | 2:1 | 1:1 | 1:1 | 1:1 |
| | pressure: | | | | | | | | | | | | | | |
| | patternization | | | | | | | | | | | | | | |
| | pressure | | | | | | | | | | | | | | |
| | Amount of | 15 | 20 | 20 | 20 | 20 | 20 | 20 | 20 | 20 | 20 | 20 | 10 | 20 | 20 |
| | coating | | | | | | | | | | | | | | |
| | material | | | | | | | | | | | | | | |
| | (cc/min) | | | | | | | | | | | | | | |
| Drying | Time | 5 | 5 | 5 | 5 | 5 | 5 | 5 | 5 | 5 | 5 | 5 | 5 | — | 3 |
| (100° C.) | (min) | | | | | | | | | | | | | | |
| Hardening | Time | 15 | 10 | 15 | 15 | 15 | 15 | 15 | 15 | 15 | 15 | 15 | 15 | 10 | 10 |
| (350° C.) | (min) | | | | | | | | | | | | | | |
| Slow | Tem- | — | — | 10 | 10 | — | — | — | — | — | — | — | — | — | 5 |
| cooling | perature | | | | | | | | | | | | | | |
| | (° C.) | | | | | | | | | | | | | | |

As shown in Table 3, Embodiments 5 to 8 according to the present disclosure are good in results of cleaning, coating workability, exterior and chemical resistance/moisture resistance. However, Comparative examples 1 to 10 are poor in one or more of results of cleaning, coating workability, exterior and chemical resistance/moisture resistance.

Comparative examples 1 and 2 are poor in results of cleaning since the spray pressure and the spray amount per hour are out of the range of the present disclosure, and Comparative examples 3 to 5 are good in the results of cleaning but poor in the coating workability and exterior since the UV irradiation is out of the range of the present disclosure.

Additionally, Comparative examples 6 and 7 are poor in the exterior since the ratio of automization pressure to patternization pressure is out of the range of the present disclosure. Comparative example 8 is poor in the coating workability and exterior since the amount of the coating material is out of the range of the disclosure.

Comparative examples 9 and 10 are poor in the exterior and the chemical resistance/moisture resistance since the drying time and hardening time are out of the range of the disclosure.

Embodiments 3 and 4 experienced the slow cooling process, and as a result of the slow cooling process, the coating film is excellent in results of cleaning, the surface energy, the coating workability, the exterior and the chemical resistance/moisture resistance.

The present disclosure is directed to a treating method of a metal surface, by which a metal surface is cleaned in a drying process and activated using short-wavelength ultraviolet rays to be coated with a glass film that is dense, thin and transparent on the metal surface.

The present disclosure is also directed to a coating method of a metal surface, which ensures improvement in superficial hardness of a coating film and prevents a change in the color of a coating film at a high temperature.

Aspects according to the present disclosure are not limited to the above ones, and other aspects and advantages that are not mentioned above can be clearly understood from the following description and can be more clearly understood from the embodiments set forth herein. Additionally, the aspects and advantages in the present disclosure can be realized via means and combinations thereof that are described in the appended claims.

To solve the above technical problems, the present disclosure uses solid carbon dioxide (CO₂) during a dry cleaning process, and comprises irradiating short-wavelength ultraviolet rays on a metal surface after the dry cleaning process.

The treating method of a metal surface according to the present disclosure may include grinding solid carbon dioxide such that the solid carbon dioxide has a certain size and then spraying the ground solid carbon dioxide onto a metal surface, and irradiating short-wavelength ultraviolet rays on the metal surface, thereby removing foreign substances attached to the metal surface, reforming the metal surface into a hydrophilic surface and improving wettability of a coating material.

In the treating method according to the present disclosure, the ground solid carbon dioxide may have a size of 0.5-3.0 mm, a pressure during the spray of the solid carbon dioxide may be 5-7 bar, and an amount of the sprayed solid carbon dioxide may be 40-60 kg/hr during the spray.

In the treating method according to the present disclosure, wavelengths of the short-wavelength ultraviolet rays may be 185-254 nm, and the short-wavelength ultraviolet rays may be irradiated at a distance of 60 mm or less away from the metal surface.

The coating method of a metal surface according to the present disclosure may include grinding solid carbon dioxide and then spraying the ground solid carbon dioxide onto a metal surface; after spraying the ground solid carbon dioxide, irradiating short-wavelength ultraviolet rays on the metal surface; and spraying a coating material onto the metal surface on which the ultraviolet rays are irradiated.

In this example, a ratio of automization pressure to patternization pressure may be 1:1 to 1:1.5 when the coating material is sprayed, and an amount of the sprayed coating material may be 15-20 cc/min when the coating material is sprayed.

A distance from a nozzle to the metal surface may be 140-180 mm when the coating material is sprayed, and a movement speed of the nozzle may be 650-1,200 mm/sec when the coating material is sprayed.

Additionally, the coating method according to the present disclosure may further include drying and hardening processes after spraying the coating material to prevent a spread and lumps of the coating material and a reduction in chemical resistance and moisture resistance of a coated surface.

The coating method according to the disclosure may further include a slow cooling process after the drying and hardening processes to prevent a coating film from being broken and cracked.

In the present disclosure, a dry type cleaning method is provided using solid carbon dioxide (CO₂), which helps to suppress generation of wastewater and prevent environmental pollution, caused during a wet type cleaning process of the related art (and/or disadvantageous arrangements) in which an alkaline degreaser and large amounts of water are used, and helps to reduce investments incurred for large facilities and a space occupied by a large facility.

Additionally, in the dry type cleaning method of the present disclosure, foreign substances and oily ingredients attached onto a metal surface are removed more perfectly using the solid CO₂ than in the wet type cleaning method of the related art (and/or disadvantageous arrangements).

Short-wavelength ultraviolet rays are irradiated after a spray of the solid CO₂ to reform the metal surface into a hydrophilic surface, thereby improving wettability of a coating material coated on the metal surface.

Further, in a treating method and a coating method of a metal surface according to the present disclosure, a small-scale treating facility is needed, thereby reducing facility investment and scaling down production lines, and there is no limitation on the selection of an area for disposing of wastewater, thereby making it possible to freely select a plant site.

Embodiments are described above with reference to a number of illustrative embodiments thereof. However, the present disclosure is not intended to limit the embodiments and drawings set forth herein, and numerous other modifications and embodiments can be devised by one skilled in the art without departing from the technical spirit of the disclosure. Further, the effects and predictable effects based on the configurations in the disclosure are to be included within the range of the disclosure though not explicitly described in the description of the embodiments.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A treating method of a metal surface, comprising:
grinding solid carbon dioxide;
spraying the ground solid carbon dioxide onto the metal surface; and
after spraying the ground solid carbon dioxide, providing short-wavelength ultraviolet rays onto the metal surface.

2. The treating method of claim 1, wherein the ground solid carbon dioxide has a size of 0.5-3.0 mm.

3. The treating method of claim 1, wherein the spraying of the ground solid carbon dioxide is performed at a pressure at 5-7 bar.

4. The treating method of claim 1, wherein an amount of the sprayed solid carbon dioxide is 40-60 kg/hr.

5. The treating method of claim 1, wherein the providing of the short-wavelength ultraviolet rays including providing ultraviolet rays having a wavelength within a range of 185-254 nm.

6. The treating method of claim 1, wherein the providing of the short-wavelength ultraviolet rays includes irradiating the short-wavelength ultraviolet rays at a distance of 60 mm or less from the metal surface.

7. The treating method of claim 1, comprising spraying a coating material onto the metal surface on which the ultraviolet rays are irradiated.

8. A coating method of a metal surface, comprising:
grinding solid carbon dioxide;
spraying the ground solid carbon dioxide onto the metal surface;
after spraying the ground solid carbon dioxide, providing short-wavelength ultraviolet rays onto the metal surface; and
spraying a coating material onto the metal surface on which the ultraviolet rays are provided.

9. The coating method of claim 8, wherein when the coating material is sprayed, a ratio of automization pressure to patternization pressure is 1:1 to 1:1.5.

10. The coating method of claim 8, wherein the spraying of the coating material includes spraying an amount of 15-20 cc/min of the coating material.

11. The coating method of claim 8, wherein when the coating material is sprayed onto the metal surface, a distance from a nozzle to the metal surface is 140-180 mm.

12. The coating method of claim 8, wherein the spraying of the coating material includes moving a nozzle at a movement speed of 650-1,200 mm/sec.

13. The coating method of claim 8, further comprising a drying process and a hardening process after the spraying of the coating material.

14. The coating method of claim 13, wherein the drying process is performed for 5-10 minutes.

15. The coating method of claim 13, wherein the hardening process is performed for 5-10 minutes.

16. The coating method of claim 13, further comprising performing a slow cooling process after the drying and hardening processes.

17. A treating method of a metal surface comprising:
providing a dry cleaning process on the metal surface by spraying solid carbon dioxide having a size of 0.5-3.0 mm onto the metal surface; and
after the dry cleaning process, providing short-wavelength ultraviolet rays onto the metal surface.

18. The treating method of claim 17, wherein an amount of the sprayed solid carbon dioxide is 40-60 kg/hr.

19. The treating method of claim 17, wherein the providing of the short-wavelength ultraviolet rays including providing ultraviolet rays having a wavelength within a range of 185-254 nm.

20. The treating method of claim 17, comprising spraying a coating material onto the metal surface on which the ultraviolet rays are provided.
